(19) United States
(12) Patent Application Publication
(10) Pub. No.: US 2023/0371114 A1
(43) Pub. Date: Nov. 16, 2023

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/144,175

(22) Filed: May 6, 2023

(30) Foreign Application Priority Data
May 12, 2022 (CN) 202210517437.7

(51) Int. Cl. H04W 76/28

(52) U.S. Cl. CPC H04W 76/28; H04W 92/18

(57) ABSTRACT

The present application discloses a method and device for wireless communications, comprising transmitting a first message on sidelink, and the first message is used to trigger a first signal; transmitting a second message, the second message comprises first location information, the first location information is based on a measurement performed on the first signal; monitoring an SCI in an active time of sidelink DRX; receiving the first signal through sidelink; herein, the active time of the sidelink DRX comprises a first time resource, and the first time resource depends on a transmission time of the first message. The present application can better support the positioning function on sidelink by transmitting a first message and receiving a first signal.

### CROSS REFERENCE TO RELATED APPLICATIONS

This application claims the priority benefit of Chinese Patent Application No. 202210517437.7, filed on May 12, 2022, the full disclosure of which is incorporated herein by reference.

### BACKGROUND

### Technical Field

The present application relates to transmission methods and devices in wireless communication systems, which is related to improve service quality of traffic, support richer traffics, save power, and in particular related to a method and device for positioning in sidelink communications.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72 plenary decided to conduct the study of New Radio (NR), or what is called fifth Generation (5G). The work Item (WI) of NR was approved at 3GPP RAN #75 plenary to standardize the NR.

In communications, whether Long Term Evolution (LTE) or 5G NR involves features of accurate reception of reliable information, optimized energy efficiency ratio, determination of information efficiency, flexible resource allocation, scalable system structure, efficient non-access layer information processing, low service interruption and dropping rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various service, improving spectrum utilization and improving service quality, which are indispensable in enhanced Mobile BroadBand (eMBB), Ultra Reliable Low Latency Communications (URLLC) and enhanced Machine Type Communications (eMTC). Meanwhile, in the following communication modes, covering Industrial Internet of Things (IIoT), Vehicular to X (V2X), Device to Device communications, Unlicensed Spectrum communications, User communication quality monitoring, network planning optimization, Non-Territorial Networks (NTN), Territorial Networks (TN), and Dual connectivity system, there are extensive requirements in radio resource management and selection of multi-antenna codebooks as well as in signaling design, adjacent cell management, service management and beamforming. Transmission methods of information are divided into broadcast transmission and unicast transmission, both of which are essential for 5G system for that they are very helpful to meet the above requirements. The UE can be connected to the network directly or through a relay.

With the increase of scenarios and complexity of systems, higher requirements are raised for interruption rate and time delay reduction, reliability and system stability enhancement, service flexibility and power saving. At the same time, compatibility between different versions of different systems should be considered when designing the systems.

### SUMMARY

In a variety of application scenarios, power saving is involved, the more effective way to save power is to use Discontinuous Reception (DRX). The principle of DRX is that a user only wakes up in part of durations to transmit and receive, and sleep in the rest of the durations. In current 5G communication network, DRX is based on period, that is, periodically waking up. However, DRX can also cause receiving latency, resulting in performance degradation, especially for traffics that require rapid response. On the other hand, the process of waking up at a user terminal is not simply a matter of waking up and falling asleep instantly, but rather requires some preparation time, which also consumes a certain amount of electricity. Therefore, frequent waking up can bring about more power consumption. In order to cope with temporary business or business with delay requirements, the DRX period can be set to be shorter, which means that the power saving effect is poor, as many times there is no need for receiving and transmitting after waking up, and the preparation time mentioned above will also bring more power consumption. Sidelink communications are widely used in scenarios such as Internet of Things (IoTs), making it more sensitive to power consumption. Furthermore, in existing sidelink communications, positioning technology is not supported, but there is a demand for positioning in sidelink communications. To support positioning technology on sidelink communications while saving power consumption is an important issue that needs to be addressed.

To address the above problem, the present application provides a solution.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:
transmitting a first message on sidelink, the first message being used to trigger a first signal; transmitting a second message, the second message comprising first location information, the first location information being based on a measurement performed on the first signal; and
monitoring Sidelink Control Information (SCI) during an active time of a sidelink Discontinuous Reception (DRX); and receiving the first signal through sidelink;
herein, the active time of the sidelink DRX comprises a first time resource, and the first time resource depends on a transmission time of the first message.

In one embodiment, a problem to be solved in the present application comprises: how to support sidelink positioning technology while saving power as much as possible.

In one embodiment, advantages of the above method comprise: supporting positioning technology on sidelink, resulting in lower power consumption and lower latency.

Specifically, according to one aspect of the present application, the behavior of monitoring an SCI during an active time of a sidelink DRX comprises detecting a first SCI; herein, the first SCI is used to determine time-domain resources occupied by the first signal.

Specifically, according to one aspect of the present application, the first message is MAC-layer control information; a first MAC PDU comprises the first message; the first MAC PDU comprises a first MAC sub-header, a first field of the first MAC sub-header comprises N1 bit(s) of a first identity of the first node, and a second field of the first MAC sub-header comprises N2 bit(s) of a second identity; the first identity of the first node and the second identity are respectively link-layer identities, and the first identity of the first node and the second identity respectively comprise N bits, N being greater than N1, N being greater than N2; the second identity is related to a transmitter of the first signal.

Specifically, according to one aspect of the present application, the first message is an SCI; the first message comprises N2 bit(s) of a first identity of the first node, and the first message comprises N1 bit(s) of a second identity; the first identity of the first node and the second identity are respectively link-layer identities, and the first identity of the first node and the second identity respectively comprise N bits, N being greater than N1, N being greater than N2; the second identity is related to a transmitter of the first signal.

Specifically, according to one aspect of the present application, a second signal is received on sidelink;
the first message is used to trigger the second signal; a reception of the second signal is later than a reception of the first signal; the first location information is based on a measurement performed on the second signal; the first time resource depends on one of a transmission time or a reception time of the second signal.

Specifically, according to one aspect of the present application, accompanying the first message, a third signal is transmitted on sidelink, and the third signal is used to determine a location of the first node; both the third signal and the first signal are physical-layer reference signals.

Specifically, according to one aspect of the present application, the first time resource starts after a determined time offset after the first message is transmitted.

Specifically, according to one aspect of the present application, the first node is an IoT terminal.

Specifically, according to one aspect of the present application, the first node is a relay.

Specifically, according to one aspect of the present application, the first node is a vehicle terminal.

Specifically, according to one aspect of the present application, the first node is an aircraft.

Specifically, according to one aspect of the present application, the first node is a mobile phone.

The present application provides a method in a second node for wireless communications, comprising:
receiving a first message on sidelink; and
transmitting a first signal on sidelink;
herein, a transmitter of the first message transmits a second message, the second message comprises first location information, and the first location information is based on a measurement performed on the first signal; the first message is used to trigger the first signal; the active time of the sidelink DRX comprises a first time resource, and the first time resource depends on a transmission time of the first message.

Specifically, according to one aspect of the present application, first SCI is transmitted; the first SCI is used to determine time-domain resources occupied by the first signal.

Specifically, according to one aspect of the present application, the first message is MAC-layer control information; a first MAC PDU comprises the first message; the first MAC PDU comprises a first MAC sub-header, a first field of the first MAC sub-header comprises N1 bit(s) of a first identity of the first node, and a second field of the first MAC sub-header comprises N2 bit(s) of a second identity; the first identity of the first node and the second identity are respectively link-layer identities, and the first identity of the first node and the second identity respectively comprise N bits, N being greater than N1, N being greater than N2; the second identity is related to a transmitter of the first signal.

Specifically, according to one aspect of the present application, the first message is an SCI; the first message comprises N2 bit(s) of a first identity of the first node, and the first message comprises N1 bit(s) of a second identity; the first identity of the first node and the second identity are respectively link-layer identities, and the first identity of the first node and the second identity respectively comprise N bits, N being greater than N1, N being greater than N2; the second identity is related to a transmitter of the first signal.

Specifically, according to one aspect of the present application, as a response to receiving the first message, a second signal is transmitted on sidelink;
a transmission of the second signal is later than a transmission of the first signal; the first location information is based on a measurement performed on the second signal; the first time resource depends on one of a transmission time or a reception time of the second signal.

Specifically, according to one aspect of the present application, a third signal is received on sidelink, and the third signal is used to determine a location of a transmitter of the first message; both the third signal and the first signal are physical-layer reference signals.

Specifically, according to one aspect of the present application, the first time resource starts after a determined time offset after the first message is transmitted.

Specifically, according to one aspect of the present application, the second node is a UE.

Specifically, according to one aspect of the present application, the second node is a relay.

Specifically, according to one aspect of the present application, the second node is a vehicle terminal.

Specifically, according to one aspect of the present application, the second node is an aircraft.

Specifically, according to one aspect of the present application, the second node is a satellite.

The present application provides a first node for wireless communications, comprising:
a first transmitter, transmitting a first message on sidelink, the first message being used to trigger a first signal; transmitting a second message, the second message comprising first location information, the first location information being based on a measurement performed on the first signal; and
a first receiver, monitoring an SCI during an active time of a sidelink DRX; and receiving the first signal through sidelink;
herein, the active time of the sidelink DRX comprises a first time resource, and the first time resource depends on a transmission time of the first message.

The present application provides a second node for wireless communications, comprising:
a second receiver, receiving a first message on sidelink; and
a second transmitter, transmitting a first signal on sidelink;
herein, a transmitter of the first message transmits a second message, the second message comprises first location information, and the first location information is based on a measurement performed on the first signal; the first message is used to trigger the first signal; the active time of the sidelink DRX comprises a first time resource, and the first time resource depends on a transmission time of the first message.

In one embodiment, the present application has the following advantages over conventional schemes:
supporting positioning service of sidelink.
reducing communication delay, which means more accurate positioning information can be obtained.
nodes in a group supporting sidelink can locate each other.
more power-saving.
the complexity of the system is low, which does not affect the basic framework of sidelink DRX.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmitting a first message and receiving a first signal according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of three nodes according to one embodiment of the present application;

FIG. 7 illustrates a schematic diagram of a reception and transmission time according to one embodiment of the present application;

FIG. 8 illustrates a schematic diagram of a resource pool according to one embodiment of the present application;

FIG. 9 illustrates a schematic diagram of a processor in a first node according to one embodiment of the present application;

FIG. 10 illustrates a schematic diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

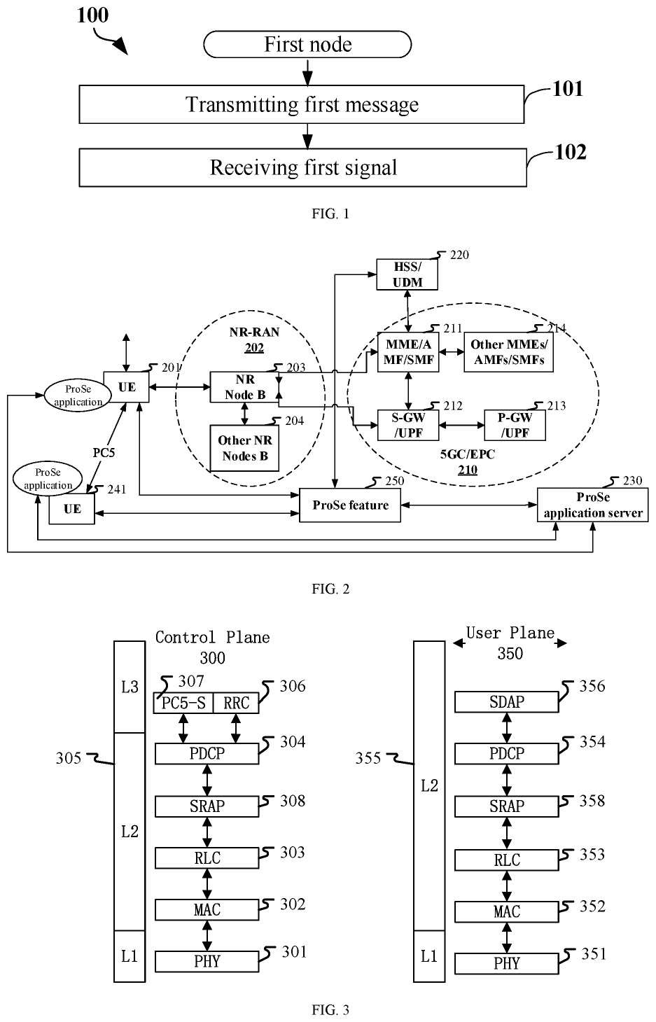

Embodiment 1 illustrates a flowchart of transmitting a first message and receiving a first signal according to one embodiment of the present application, as shown in FIG. 1. In FIG. 1, each step represents a step, it should be particularly noted that the sequence order of each box herein does not imply a chronological order of steps marked respectively by these boxes.

In embodiment 1, a first node in the present application transmits a first message in step 101; receives a first signal in step 102;
herein, the first message is transmitted on sidelink, and the first message is used to trigger a first signal; a second message is transmitted, the second message comprises first location information, the first location information is based on a measurement performed on the first signal;
an SCI is monitored during an active time of a sidelink DRX; and the first signal is received through sidelink; the active time of the sidelink DRX comprises a first time resource, and the first time resource depends on a transmission time of the first message.

In one embodiment, the first node is a User Equipment (UE).

In one embodiment, the first node is in RRC CONNECTED state.

In one embodiment, the first node is in RRC IDLE state.

In one embodiment, the first node is in RRC INACTIVE state.

In one embodiment, the first node is located within the coverage of network.

In one embodiment, the first node is located outside the coverage of network.

In one embodiment, a transmitter of the first signal is located within the network coverage.

In one embodiment, a transmitter of the first signal is located outside the network coverage.

In one embodiment, the sidelink in the present application refers to a link between a UE and a UE.

In one embodiment, the sidelink in the present application refers to a radio link between a UE and a UE.

In one embodiment, the sidelink in the present application refers to not comprising a link between a UE and network.

In one embodiment, the sidelink in the present application refers to not comprising a link between a UE and a base station.

In one embodiment, the concept of uplink and downlink does not exist in the sidelink of the present application.

In one embodiment, the behavior of transmitting on sidelink refers to using resources of sidelink for a transmission, and the transmitted information uses a sidelink physical channel.

In one subembodiment of the embodiment, the sidelink physical channel comprises a physical sidelink shared channel (PSSCH) and a physical sidelink control channel (PSCCH).

In one subembodiment of the embodiment, a potential receiver of the behavior of transmitting on sidelink is other UEs instead of a base station or a cell.

In one subembodiment of the embodiment, a transmitter corresponding to the behavior of transmitting on sidelink is a UE.

In one embodiment, the behavior of receiving on sidelink refers to receiving on sidelink resources, and the received information uses a sidelink physical channel.

In one subembodiment of the embodiment, the sidelink physical channel comprises a physical sidelink shared channel (PSSCH) and a physical sidelink control channel (PSCCH).

In one subembodiment of the embodiment, a potential receiver of the behavior of receiving on sidelink is other UEs instead of a base station or a cell.

In one subembodiment of the embodiment, a transmitter corresponding to the behavior of receiving on sidelink is a UE.

In one embodiment, an SCI occupies a sidelink physical channel PSCCH.

In one embodiment, an SCI occupies a sidelink physical channel PSSCH.

In one embodiment, the second message is delivered via at least an air interface.

In one embodiment, the second message is delivered via an interface between a base station and a location service center as well as uplink.

In one embodiment, the second message is transmitted via sidelink.

In one embodiment, the second message is transmitted for a transmitter of the first signal.

In one embodiment, the second message is transmitted to a relay of the first node, and is forwarded to other nodes via a relay node.

In one subembodiment of the embodiment, the other nodes are a base station or a cell or a cell group.

In one subembodiment of the embodiment, the other nodes are other UEs.

In one embodiment, the second message is transferred inside the first node.

In one embodiment, the behavior of transmitting a second message comprises: a lower layer of the first node delivers the second message to a higher layer of the first node.

In one embodiment, the second message comprises a first timestamp.

In one embodiment, the first timestamp is referenced to a timing of a third node, i.e., a node other than the first node and a transmitter of the first signal.

In one subembodiment of the embodiment, the third node is a UE.

In one embodiment, the first timestamp is a reception time of the first signal.

In one embodiment, the first timestamp is a transmission time of the first signal.

In one embodiment, the first timestamp is a time when the measurement performed on the first location information is executed.

In one embodiment, the first timestamp comprises a direct frame number (DFN).

In one embodiment, the first timestamp comprises a slot number.

In one embodiment, the first timestamp comprises a System Frame Number (SFN) and a Slot Number.

Typically, the first location information comprises at least one of first time location information or first receiving power information.

In one embodiment, a resolution of the first time location information is Ts, where Ts is 1/(15000*2048) s.

In one embodiment, a resolution of the first time location information is 4 Ts, where Ts is 1/(15000*2048) s.

In one embodiment, a resolution of the first time location information is N times Ts, where Ts is 1/(15000*2048) s, N being a positive integer.

In one embodiment, the first receiving power information is measured by dBm.

In one embodiment, the first receiving power information is measured by dB.

In one embodiment, the first time location position comprises Reference Signal Time Difference (RSTD).

In one embodiment, the first time location information comprises RxTxTimeDiff.

In one embodiment, the first time location information comprises Relative Time of Arrival (RTOA).

In one embodiment, the first receiving power information comprises Reference Signal Received Power (RSRP) of the first signal.

In one embodiment, the first receiving power information comprises Reference Signal Received Path Power (RSRPP) of the first signal.

In one embodiment, the first location information comprises the first time location information.

In one embodiment, the first location information comprises the first time location information and the first receiving power information.

In one embodiment, the first message indicates a type of the first signal; the type of the first signal comprises a positioning reference signal (PRS) and a sounding reference signal (SRS).

In one embodiment, the first location information comprises location information from other nodes.

In one embodiment, the first location information comprises location information from other UEs.

In one embodiment, the first location information comprises distance from other fixed nodes.

In one embodiment, the first location information comprises distance from other mobile nodes.

In one embodiment, the first location information comprises integrity of location information.

In one embodiment, the first message indicates location accuracy requirement.

In one embodiment, the first message indicates accuracy requirement of the first signal.

In one embodiment, the first message indicates integrity requirement of the first signal.

In one embodiment, the first message indicates a resource pool or frequency-domain resources occupied by the first signal.

In one embodiment, the first signal is used for positioning.

In one embodiment, the first signal is a physical-layer reference signal.

In one embodiment, the first signal is a reference signal dedicated for positioning.

In one embodiment, the first signal is transmitted via sidelink.

In one embodiment, the first signal is generated by physical layer.

In one embodiment, the first signal occupies a PSSCH.

In one embodiment, the first signal occupies a PSCCH.

In one embodiment, the meaning of the phrase that the first message is used to trigger a first signal comprises: the first message requests opposite peer end to transmit the first signal.

In one embodiment, the meaning of the phrase that the first message is used to trigger a first signal comprises: a receiver of the first message transmits the first signal upon a reception of the first message.

In one embodiment, the meaning of the phrase that the first message is used to trigger a first signal comprises: a transmission of the first signal is triggered by the first message.

In one embodiment, the meaning of the phrase that the first message is used to trigger a first signal comprises: a transmission of the first signal is based on demand, and the based on demand refers to a request based on the first message.

In one embodiment, the second message is a NAS message.

In one embodiment, the second message is an RRC message.

In one embodiment, the second message is a PC5-S message.

In one embodiment, the second message is information or physical-layer information of MAC layer.

In one embodiment, the second message comprises information used for positioning.

In one embodiment, the first node performs a measurement on the first signal to obtain the first location information.

In one embodiment, a measurement result comprised in the first location information comprises a measurement result performed on the first signal.

In one subembodiment of the embodiment, the measurement result for the first signal comprises an RSTD.

In one subembodiment of the embodiment, the measurement result for the first signal comprises RxTxTimeDiff.

In one subembodiment of the embodiment, the measurement result for the first signal comprises an RTOA.

In one subembodiment of the embodiment, the measurement result for the first signal comprises RSRPP.

In one subembodiment of the embodiment, the measurement result for the first signal comprises RSRP of a first path for a PRS.

In one subembodiment of the embodiment, the measurement result for the first signal comprises information related to TEG.

In one subembodiment of the embodiment, the measurement result for the first signal comprises timing quality.

In one subembodiment of the embodiment, the measurement result for the first signal comprises an extra receiving and transmitting time difference.

In one subembodiment of the embodiment, the measurement result for the first signal comprises an SRS transmitting TEG information.

In one subembodiment of the embodiment, the measurement result for the first signal comprises an identity of the first signal.

In one embodiment, sidelink DRX refers to an SL DRX.

In one embodiment, an SCI is only transmitted through sidelink.

In one embodiment, the behavior of monitoring an SCI comprises performing blindly decoding on a configured resource pool.

In one embodiment, the behavior of monitoring an SCI comprises verifying whether a received SCI is for the first node.

In one embodiment, the behavior of monitoring an SCI comprises verifying whether a received SCI comprises at least partial bits of an identity of the first node.

In one subembodiment of the embodiment, the behavior monitoring an SCI comprises verifying whether a destination layer-1 ID field of a received SCI comprises 8 least significant bits of a Layer-2 ID of the first node.

In one subembodiment of the embodiment, the behavior monitoring an SCI comprises verifying whether a destination layer-1 ID field of a received SCI comprises 16 least significant bits of a Layer-2 ID of the first node.

In one embodiment, the behavior of monitoring an SCI comprises verifying whether a received SCI is transmitted by a target receiver of the first message.

In one embodiment, the behavior of monitoring an SCI comprises verifying whether a received SCI comprises at least partial bits of an identity of a target receiver of the first message.

In one subembodiment of the embodiment, the behavior monitoring an SCI comprises verifying that a source Layer-1 ID field of a received SCI comprises 8 least significant bits of a second identity, and the second identity comprises 24 bits; a destination Layer-2 ID field of a sub-header of a MAC PDU carrying the first message comprises the 8 most significant bits of the second identity.

In one embodiment, the first message is MAC-layer control information.

In one embodiment, the first message is a MAC CE.

In one embodiment, the first message is an SCI.

In one embodiment, the first message is sidelink control information.

In one embodiment, the first signal occupies sidelink resources.

In one embodiment, a physical channel used by the first signal comprises a PSSCH.

In one embodiment, a physical channel used by the first signal comprises a PSCCH.

In one embodiment, the first node monitors an SCI only in active time of sidelink DRX.

In one embodiment, the sidelink DRX is an SL DRX for a transmitter of the first signal.

In one embodiment, time-domain resources occupied by the first time resource are limited.

In one embodiment, time-domain resources occupied by the first time resource do not exceed a sidelink DRX period.

In one embodiment, an upper limit of time-domain resources occupied by the first time resource is configured by the first node by itself.

In one embodiment, an upper limit of time-domain resources occupied by the first time resource is configured by a primary cell of the first node.

In one embodiment, an upper limit of time-domain resources occupied by the first time resource is configured by a transmitter of the first signal.

In one embodiment, an upper limit of time-domain resources occupied by the first time resource is pre-configured.

In one embodiment, time-domain resources occupied by the first time resource are do not exceed 160 slots.

In one embodiment, time-domain resources occupied by the first time resource are do not exceed 32 slots.

In one embodiment, the first message indicates a maximum delay from receiving the first message to transmitting the first signal.

In one embodiment, the active time of the sidelink DRX comprises all of the first time resource.

In one embodiment, the meaning of the phrase that the first time resource depends on a transmission time of the first message comprises: the first time resource starts from a transmission of the first message.

In one embodiment, the meaning of the phrase that the first time resource depends on a transmission time of the first message comprises: a transmission of the first message is a start of the first time resource.

In one embodiment, the meaning of the phrase that the first time resource depends on a transmission time of the first message comprises: the first time resource starts from a first slot after the first message is transmitted.

In one embodiment, the meaning of the phrase that the first time resource depends on a transmission time of the first message comprises: a time offset after the first message being transmitted is a start of the first time resource.

In one subembodiment of the above embodiment, the time offset is indicated through an RRC message.

In one subembodiment of the above embodiment, the time offset is indicated through an RRC message of a PC5 interface.

In one subembodiment of the above embodiment, the time offset is related to a time-frequency resource pool used by the first signal.

In one subembodiment of the above embodiment, the first message indicates the time offset.

In one embodiment, the first message indicates the first time resource.

In one embodiment, the first message indicates a start of the first time resource.

In one embodiment, the meaning of the phrase that the first time resource depends on a transmission time of the first message comprises: a time for transmitting the first message is used to determine the first time resource.

In one embodiment, the first time-frequency resource is unrelated to whether an onduration timer for the sidelink DRX is running

In one embodiment, the first time-frequency resource starts when an onduration timer of the sidelink DRX expires, and an onduration timer for the sidelink DRX is running when the first message is transmitted.

In one embodiment, the first time-frequency resource is unrelated to whether an inactivity timer for the sidelink DRX is running.

In one embodiment, the first time-frequency resource is unrelated to whether a retransmission timer for the sidelink DRX is running.

In one embodiment, the behavior of monitoring an SCI during an active time of a sidelink DRX comprises detecting a first SCI; herein, the first SCI is used to determine time-domain resources occupied by the first signal.

Typically, only when the first SCI is detected, the behavior of receiving the first signal through sidelink is executed.

In one embodiment, the first message is used to trigger the first SCI.

In one embodiment, the first SCI is a response for the first message.

In one embodiment, the first SCI indicates an identity of the first node.

In one embodiment, the first SCI indicates time-domain resources occupied by the first signal.

In one embodiment, the first SCI is divided into two parts, where a second part indicates that the first signal is a PRS.

In one embodiment, the first message is MAC-layer control information; a first MAC PDU comprises the first message; the first MAC PDU comprises a first MAC sub-header, a first field of the first MAC sub-header comprises N1 bit(s) of a first identity of the first node, and a second field of the first MAC sub-header comprises N2 bit(s) of a second identity; the first identity of the first node and the second identity are respectively link-layer identities, and the first identity of the first node and the second identity respectively comprise N bits, N being greater than N1, N being greater than N2; the second identity is related to a transmitter of the first signal.

In one subembodiment of the above embodiment, N is equal to 24.

In one subembodiment of the above embodiment, N1 is equal to 16, and N2 is equal to 8.

In one subembodiment of the above embodiment, N1 is equal to 8, and N2 is equal to 16.

In one subembodiment of the above embodiment, N1, N2 and N meet N1+N2=N.

In one subembodiment of the above embodiment, the first field is a source Layer-2 ID field.

In one subembodiment of the above embodiment, the first field is an SRC field.

In one subembodiment of the above embodiment, the second field is a destination Layer-2 ID field.

In one subembodiment of the above embodiment, the second field is a DST field.

In one subembodiment of the above embodiment, the first identity of the first node is a Layer-2 ID of the first node.

In one subembodiment of the above embodiment, the first identity of the first node is an L2 ID of the first node.

In one subembodiment of the above embodiment, the first identity of the first node is an identity used to distinguish an identity of each UE during sidelink communications, and the first identity of the first node is determined during a direct connection establishment procedure of sidelink communications.

In one subembodiment of the above embodiment, the second ID is a Layer-2 ID of a transmitter of the first signal.

In one subembodiment of the above embodiment, the second ID is the group Layer-2 ID of a transmitter of the first signal.

In one subembodiment of the above embodiment, the second identity is a layer-2 ID of a group.

In one subembodiment of the embodiment, the second identity is used to indicate that the first signal is used for positioning.

In one subembodiment of the embodiment, the second identity is used to indicate that the first signal is a PRS.

In one subembodiment of the embodiment, the first MAC PDU comprises a first MAC sub-PDU, and a header of the first MAC sub-PDU is the first MAC sub-header.

In one subembodiment of the above embodiment, N, N1 and N2 are respectively positive integers.

In one embodiment, the first message is unicast.

In one embodiment, the first signal is unicast.

In one embodiment, the first signal is groupcast.

In one embodiment, the first signal is broadcast.

In one embodiment, the link-layer identity is a Layer-2 ID.

In one embodiment, the link-layer identity is an L2 ID.

In one embodiment, the L2 ID is a Layer-2 ID.

In one embodiment, the first message is an SCI; the first message comprises N2 bit(s) of a first identity of the first node, and the first message comprises N1 bit(s) of a second identity; the first identity of the first node and the second identity are respectively link-layer identities, and the first identity of the first node and the second identity respectively comprise N bits, N being greater than N1, N being greater than N2; the second identity is related to a transmitter of the first signal.

In one subembodiment of the above embodiment, N is equal to 24.

In one subembodiment of the above embodiment, N1 is equal to 16, and N2 is equal to 8.

In one subembodiment of the above embodiment, N1 is equal to 8, and N2 is equal to 16.

In one subembodiment of the above embodiment, N1, N2 and N meet N1+N2=N.

In one subembodiment of the above embodiment, the first field is a source Layer-1 ID field.

In one subembodiment of the above embodiment, the first field is an SRC field.

In one subembodiment of the above embodiment, the second field is a destination Layer-1 ID field.

In one subembodiment of the above embodiment, the second field is a DST field.

In one subembodiment of the above embodiment, the first identity of the first node is a Layer-2 ID of the first node.

In one subembodiment of the above embodiment, the first identity of the first node is an L2 ID of the first node.

In one subembodiment of the above embodiment, the first identity of the first node is an identity used to distinguish an identity of each UE during sidelink communications, and the first identity of the first node is determined during a direct connection establishment procedure of sidelink communications.

In one subembodiment of the above embodiment, the second ID is a Layer-2 ID of a transmitter of the first signal.

In one subembodiment of the above embodiment, the second ID is the group Layer-2 ID of a transmitter of the first signal.

In one subembodiment of the above embodiment, the second identity is a group layer-2 ID.

In one subembodiment of the embodiment, the second identity is used to indicate that the first signal is used for positioning.

In one subembodiment of the embodiment, the second identity is used to indicate that the first signal is a PRS.

In one subembodiment of the above embodiment, N, N1 and N2 are respectively positive integers.

In one embodiment, at least one of a source identity or a destination identity indicated by the first message is different from a source identity and a destination identity indicated by the first signal.

In one embodiment, whether at least one of a source identity and a destination identity indicated by the first message is a node identity or a group identity is related to whether the first node establishes a direct link with a transmitter of the first signal; when the first node establishes a direct link with a transmitter of the first signal, a source identity and a destination identity indicated by the first message are respectively an identity of the first node and an identity of a transmitter of the first signal; when a direct link is not established between the first node and a transmitter of the first signal, at least one of a source identity and a destination identity indicated by the first message is a group identity.

In one embodiment, whether at least one of a source identity and a destination identity indicated by the first SCI is a node identity or a group identity is related to whether the first node establishes a direct link with a transmitter of the first signal; when the first node establishes a direct link with a transmitter of the first signal, a source identity and a destination identity indicated by the first SCI are respectively an identity of the first node and an identity of a transmitter of the first signal; when a direct link is not established between the first node and a transmitter of the first signal, at least one of a source and a destination identity indicated by the first SCI is a group identity.

In one embodiment, the behavior of monitoring an SCI comprises verifying whether a received SCI is used to indicate that the first node is a destination node.

### Embodiment 2

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS). To support positioning services, network elements or functional nodes related to positioning services can also be comprised in the network, such as Location Management Function (LMF). LMF can be a logical unit or exist in a physical entity. LMF can be a positioning server, for example, LMF can belong to 211 or 214 in FIG. 2. LMF and AMF can have a communication interface, such as NL1 interface, and a UE can communicate with LMF through AMF.

In one embodiment, the first node in the present application is a UE 201.

In one embodiment, the second node in the present application is a UE 201.

In one embodiment, a radio link between the UE 201 and NR node B is an uplink.

In one embodiment, a radio link between NR node B and UE 201 is a downlink.

In one embodiment, the UE 201 supports relay transmission.

In one embodiment, the UE 201 comprises a mobile phone.

In one embodiment, the UE 201 is a vehicle comprising a car.

In one embodiment, the UE 201 supports sidelink communications.

In one embodiment, the UE 201 supports MBS transmission.

In one embodiment, the UE 241 supports relay transmission.

In one embodiment, the UE 241 comprises a mobile phone.

In one embodiment, the UE 241 is a vehicle comprising a car.

In one embodiment, the UE 241 supports sidelink transmission.

In one embodiment, the UE 241 supports MBS transmission.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a flight platform.

In one embodiment, the gNB 203 is satellite equipment.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE, gNB or a satellite or an aircraft in NTN) and a second node (gNB, UE or a satellite or an aircraft in NTN), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first node and a second node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second node and a first node. PC5 Signaling Protocol (PC5-S) sublayer 307 is responsible for the processing of signaling protocol at PC5 interface. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. SRB can be seen as a service or interface provided by the PDCP layer to a higher layer, such as the RRC layer. In NR system, SRBs comprise SRB1, SRB2, SRB3, and when it comes to sidelink communications, there is also SRB4, which is used to transmit different types of control signalings. SRB, a bearer between a UE and access network, is used to transmit a control signaling, comprising an RRC signaling, between UE and access network. SRB1 has special significance for UE. After each UE establishes an RRC connection, there will be SRB1 used to transmit an RRC signaling Most of the signalings are transmitted through SRB1. If SRB1 is interrupted or unavailable, the UE must perform RRC reconstruction. SRB2 is generally used only to transmit an NAS signaling or signaling related to security aspects. The UE can be configured without SRB3. Except for emergency services, the UE must establish an RRC connection to the network for subsequent communication. Although not described in the figure, the first node may comprise several higher layers above the L2 305 also comprises a network layer (i.e., IP layer) terminated at a P-GW 213 of the network side and an application layer terminated at the other side of the connection (i.e., a peer UE, a server, etc.). For UE involving relay service, its control plane can also comprise the adaptation sub-layer Sidelink Relay Adaptation Protocol (SRAP) 308, and its user plane can also comprise the adaptation sub-layer SRAP358, the introduction of the adaptation layer helps lower layers, such as MAC layer, RLC layer, to multiplex and/or distinguish data from multiple source UEs. For a node not involving relay communications, the communication procedure does not require PC5-S307, SRAP308 and SRAP358. Sidelink RRC, that is, a peer RRC entity of an RRC entity of a UE is within another UE, can also be referred to as RRC of a PC5 interface or PC5-RRC.

In one embodiment, the radio protocol architecture in FIG. 3 is applicable to the first node in the present application.

In one embodiment, the radio protocol architecture in FIG. 3 is applicable to the second node in the present application.

In one embodiment, the first message in the present application is generated by the MAC 302 or the PHY 301.

In one embodiment, the first signal in the present application is generated by the MAC 302 or the PHY 301 or the PHY 351.

In one embodiment, the first SCI in the present application is generated by the PHY 301.

In one embodiment, the second signal in the present application is generated by the MAC 302 or the PHY 301 or the PHY 351.

In one embodiment, the third signal in the present application is generated by the MAC 302 or the PHY 301 or the PHY 351.

In one embodiment, the second message in the present application is generated by the MAC 302 or the PHY 301 or the RRC 305 or the PC5-S307.

In one embodiment, the second message in the present application is generated at NAS layer or LTE positioning protocol (LPP) layer.

### Embodiment 4

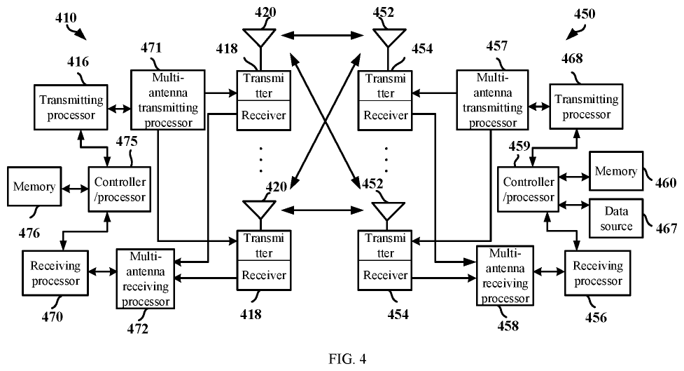

Embodiment 4 illustrates a schematic diagram of a first communication device and a second communication device according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, optionally may also comprise a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, optional can also comprise a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: transmits a first message on sidelink, the first message is used to trigger a first signal; transmits a second message, the second message comprises first location information, the first location information is based on a measurement performed on the first signal;
monitors an SCI during an active time of a sidelink DRX; and receives the first signal through sidelink; herein, the active time of the sidelink DRX comprises a first time resource, and the first time resource depends on a transmission time of the first message.

In one embodiment, the first communication device 450 comprises at least one processor and at least one memory a memory that stores a computer readable instruction program. The computer readable instruction program generates an action when executed by at least one processor. The action includes: transmitting a first message on sidelink, the first message being used to trigger a first signal; transmitting a second message, the second message comprising first location information, the first location information being based on a measurement performed on the first signal; monitoring an SCI during an active time of a sidelink DRX; and receiving the first signal through sidelink; herein, the active time of the sidelink DRX comprises a first time resource, and the first time resource depends on a transmission time of the first message.

In one embodiment, the second communication device 410 comprises at least one processor and at least one memory. The at least one memory comprises computer program codes; the at least one memory and the computer program codes are configured to be used in collaboration with the at least one processor, the second communication device 410 at least: receives a first message on sidelink; and transmits a first signal on sidelink; herein, a transmitter of the first message transmits a second message, the second message comprises first location information, and the first location information is based on a measurement performed on the first signal; the first message is used to trigger the first signal; the active time of the sidelink DRX comprises a first time resource, and the first time resource depends on a transmission time of the first message.

In one embodiment, the second communication device 410 comprises a memory that stores a computer readable instruction program. The computer readable instruction program generates an action when executed by at least one processor. The action includes: receiving a first message on sidelink; and transmitting a first signal on sidelink; herein, a transmitter of the first message transmits a second message, the second message comprises first location information, and the first location information is based on a measurement performed on the first signal; the first message is used to trigger the first signal; the active time of the sidelink DRX comprises a first time resource, and the first time resource depends on a transmission time of the first message.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a vehicle terminal.

In one embodiment, the second communication device 450 is a relay.

In one embodiment, the second communication device 410 is a satellite.

In one embodiment, the second communication device 410 is an aircraft.

In one embodiment, the first communication device 410 is a UE.

In one embodiment, the first communication device 410 is a relay.

In one embodiment, the receiver 454 (comprising the antenna 452), the receiving processor 456 and the controller/processor 459 are used to receive the first signal in the present application.

In one embodiment, the receiver 454 (comprising the antenna 452), the receiving processor 456 and the controller/processor 459 are used to receive the second signal in the present application.

In one embodiment, the receiver 454 (comprising the antenna 452), the receiving processor 456 and the controller/processor 459 are used to receive the first SCI in the present application.

In one embodiment, the transmitter 454 (comprising antenna 452), the transmitting processor 468 and the controller/processor 459 are used to transmit the first message in the present application.

In one embodiment, the transmitter 454 (comprising antenna 452), the transmitting processor 468 and the controller/processor 459 are used to transmit the second message in the present application.

In one embodiment, the transmitter 454 (comprising antenna 452), the transmitting processor 468 and the controller/processor 459 are used to transmit the third signal in the present application.

In one embodiment, the transmitter 418 (comprising the antenna 420), the transmitting processor 416 and the controller/processor 475 are used to transmit the first information in the present application.

In one embodiment, the transmitter 418 (comprising the antenna 420), the transmitting processor 416 and the controller/processor 475 are used to transmit the second information in the present application.

In one embodiment, the transmitter 418 (comprising the antenna 420), the transmitting processor 416 and the controller/processor 475 are used to transmit the third signal in the present application.

In one embodiment, the transmitter 418 (comprising the antenna 420), the transmitting processor 416 and the controller/processor 475 are used to transmit the first SCI in the present application.

In one embodiment, the receiver 418 (comprising the antenna 420), the receiving processor 470 and the controller/processor 475 are used to receive the first message in the present application.

In one embodiment, the receiver 418 (comprising the antenna 420), the receiving processor 470 and the controller/processor 475 are used to receive the third signal in the present application.

In one embodiment, the receiver 418 (comprising the antenna 420), the receiving processor 470 and the controller/processor 475 are used to receive the second message in the present application.

### Embodiment 5

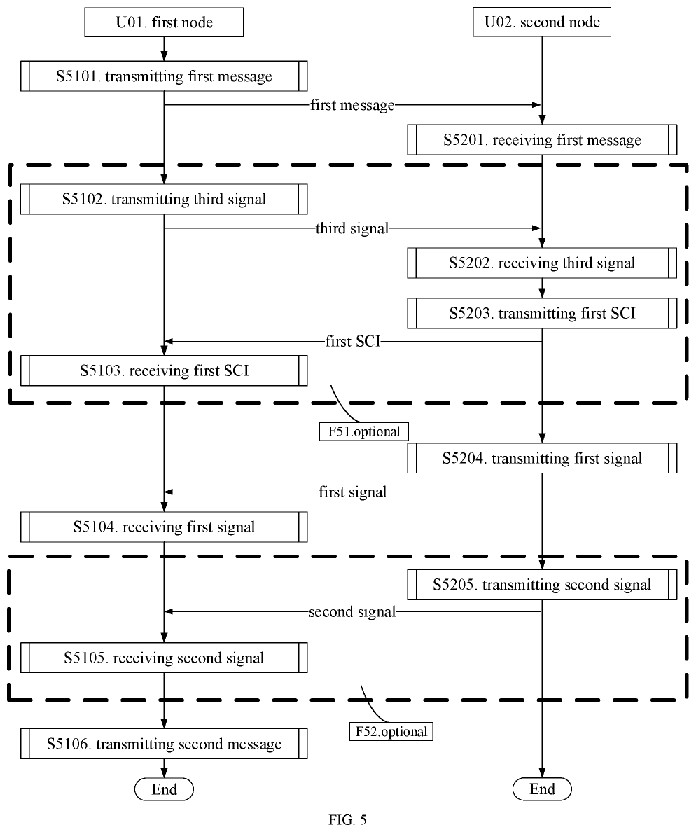

Embodiment 5 illustrates a flowchart of radio signal transmission according to one embodiment in the present application, as shown in FIG. 5. In FIG. 5, U01 corresponds to a first node in the present application, U02 corresponds to a second node in the present application. It is particularly underlined that the order illustrated in the embodiment does not put constraints over sequences of signal transmissions and implementations and steps in F51 and F52 are optional.

The first node U01 transmits a first message in step S5101; transmits a third signal in step S5102; receives a first SCI in step S5103; receives a first signal in step S5104; receives a second signal in step S5105; transmits a second message in step S5106.

The second node U02 receives a first message in step S5201; receives a third signal in step S5202; transmits a first SCI in step S5203; transmits a first signal in step S5204; transmits a second signal in step S5205;

In embodiment 5, the first message is transmitted on sidelink, and the first message is used to trigger the first signal; the second message comprises first location information, the first location information is based on a measurement performed on the first signal;
the first node U01, monitors an SCI during an active time of a sidelink DRX; and receives the first signal through sidelink;
herein, the active time of the sidelink DRX comprises a first time resource, and the first time resource depends on a transmission time of the first message.

In one embodiment, both the first node U01 and the second node U02 are UEs.

In one embodiment, a link between the first node U01 and the second node U02 is sidelink.

In one embodiment, a direct link is established between the first node U01 and the second node U02.

In one embodiment, a direct link is not established between the first node U01 and the second node U02.

In one embodiment, a PC5 RRC connection is established between the first node U01 and the second node U02.

In one embodiment, a PC5 RRC connection is not established between the first node U01 and the second node U02.

In one embodiment, the first node U01 is a relay UE of the second node U02.

In one embodiment, the second node U02 is a relay UE of the first node U01.

In one embodiment, the first node U01 is a cluster head of the second node U02.

In one embodiment, the second node U02 is a cluster head of the first node U01.

In one embodiment, before the first message, the first node U01 and the second node U02 configure the first message through an RRC message of a PC5 interface.

In one subembodiment of the above embodiment, the phrase of configuring the first message comprises configuring at least one parameter comprised in the first message.

In one subembodiment of the above embodiment, the phrase of configuring the first message comprises configuring resources occupied by the first message.

In one subembodiment of the above embodiment, the phrase of configuring the first message comprises configuring a transmission time of the first message.

In one subembodiment of the above embodiment, the phrase of configuring the first message comprises configuring a resource pool occupied by the first message.

In one embodiment, before the first message, the first node U01 and the second node U02 configure a sidelink DRX through an RRC message of a PC5 interface.

In one subembodiment of the above embodiment, the sidelink DRX is for the second node U02.

In one subembodiment of the above embodiment, the sidelink DRX is for a communication pair of the first node U01 and the second node U02.

In one embodiment, before the first message, the first node U01 and the second node U02 configure a time interval between the first signal and the first message through an RRC message of a PC5 interface.

In one embodiment, before the first message, the first node U01 and the second node U02 configure a maximum time interval between the first signal and the message through an RRC message of a PC5 interface.

In one embodiment, before the first message, the first node U01 and the second node U02 configure the first signal through an RRC message of a PC5 interface.

In one subembodiment of the above embodiment, the phrase of configuring the first signal comprises configuring a type of the first signal.

In one subembodiment of the embodiment, the phrase of configuring the first signal comprises configuring a resource pool used by the first signal.

In one subembodiment of the embodiment, the phrase of configuring the first signal comprises configuring a number of times that the first signal is transmitted.

In one subembodiment of the embodiment, the phrase of configuring the first signal comprises configuring power of the first signal.

In one subembodiment of the embodiment, the phrase of configuring the first signal comprises configuring a Layer-2 ID used by the first signal.

In one embodiment, the first message is a MAC CE.

In one embodiment, the first message is an SCI.

In one embodiment, the first message is a MAC sub-header.

In one embodiment, the first message does not comprise a PDU above the MAC layer.

In one embodiment, the third signal is transmitted on sidelink.

In one embodiment, the third message is transmitted accompanying the first message.

In one embodiment, the third signal is a PRS, and the first signal is an SRS.

In one embodiment, the first signal is a PRS, and the third signal is an SRS.

In one embodiment, both the third signal and the first signal are PRSs or SRSs.

In one embodiment, a transmission of the third signal is earlier than a reception of the first signal.

In one embodiment, a type of the third signal is used to determine a type of the first signal.

In one embodiment, a resource pool occupied by the third signal is used to determine a resource pool used by the first signal.

In one embodiment, frequency occupied by the third signal is used to determine frequency used by the first signal.

In one embodiment, the third signal is different from the first signal.

In one embodiment, the third signal is used for positioning.

In one embodiment, the third signal and the first message are transmitted at the same time.

In one embodiment, the third signal and the first message are transmitted at different frequencies.

In one embodiment, time-domain resources occupied by the third signal are later than time-domain resources occupied by the first message.

In one embodiment, the third signal is a physical-layer signal.

In one embodiment, the third signal is a reference signal of physical layer.

In one embodiment, the third signal is a PRS.

In one embodiment, the third signal is a reference signal dedicated for positioning.

In one embodiment, both the third signal and the first signal are SLPRSs or SPRSs or SL-PRSs.

In one embodiment, the first signal and the third signal occupy a same resource pool.

In one embodiment, the first signal and the third signal occupy same frequency domain

In one embodiment, the advantage of the above method is that it facilitates the mutual positioning of two nodes and can also increase the accuracy of positioning.

In one embodiment, the second node U02 starts a first timer after receiving the first message, and a transmission of the first signal is not later than an expiration of the first timer.

In one subembodiment of the above embodiment, the first timer is configured by a PC5-RRC message.

In one subembodiment of the above embodiment, the first node U01 and the second node U02 configure the first timer through the RRC message of a PC5 interface.

In one embodiment, the first signal is transmitted accompanying the first SCI.

In one embodiment, before transmitting the first message, the first node U01 transmits a second SCI, and the second SCI is used to indicate time-frequency resources occupied by the first message.

In one embodiment, the first node U01 transmits a first discovery message, and the first discovery message is used for a discovery on a direct link; the first discovery message comprises a first identity of the first node, and the first identity is a Layer-2 ID; a source identity indicated by a MAC sub-header of a MAC PDU comprising the first message is different from the first identity.

In one embodiment, a source layer-1 ID field of the first SCI comprises 8 least significant bits of a layer-2 ID of the first node U01.

In one embodiment, a source layer-1 ID field of the first SCI comprises 16 least significant bits of a layer-ID of the first node U01.

In one embodiment, the first SCI indicates that the first signal comprises a PRS or comprises an SRS.

In one embodiment, the first SCI indicates that the first signal only comprises a PRS or only comprises an SRS.

In one embodiment, the first SCI indicates a new transmission.

In one embodiment, the first SCI does not indicate a new transmission.

In one embodiment, a reception of the first SCI is used to trigger starting an inactivity timer of sidelink DRX.

In one embodiment, the first signal is a PRS.

In one embodiment, the first signal is an SRS.

In one embodiment, the first signal comprises a MAC sub-header.

In one embodiment, the first signal comprises a MAC CE.

In one embodiment, the first signal does not comprise a PDU of a MAC layer.

In one embodiment, the first node U01 receives a second signal on sidelink.

In one embodiment, the first message is used to trigger a transmission of the second signal.

In one embodiment, a reception of the second signal is later than a reception of the first signal;

In one embodiment, a transmission of the second signal is later than a transmission of the first signal.

In one embodiment, a transmission of the second signal is earlier than a transmission of the first signal.

In one embodiment, a reception of the second signal is earlier than a reception of the first signal.

In one embodiment, the second signal is earlier than the first signal.

In one embodiment, the first location information is based on a measurement performed on the second signal.

In one embodiment, the first time resource depends on a transmission time of the second signal.

In one embodiment, the first time resource depends on a reception time of the second signal.

In one embodiment, the second signal is a PRS.

In one embodiment, the second signal is an SRS.

In one embodiment, the first signal is a PRS, and the second signal is an SRS.

In one embodiment, the first signal is an SRS, and the second signal is a PRS.

In one embodiment, the first signal is a PRS, and the second signal is a PRS.

In one embodiment, the first signal is an SRS, and the second signal is a PRS.

In one embodiment, a type of the first signal and a type of the second signal are the same.

In one embodiment, a type of the first signal and a type of the second signal are different.

In one embodiment, the advantage of the above methods is that richer signals for positioning can be provided for the first node, which is beneficial for improving positioning accuracy.

In one embodiment, a time interval between the first signal and the second signal is determined.

In one embodiment, a time interval between the first signal and the second signal are configured through an RRC message between the first node U01 and the second node U02.

In one embodiment, the first message indicates whether the second signal is requested.

In one embodiment, a field in the first message being 1 is used to trigger the second signal.

In one subembodiment of the above embodiment, if a value of the field in the first message is 0, the second signal is not triggered.

In one subembodiment of the above embodiment, the vacancy in the field of the first message does not trigger the second signal.

In one embodiment, a field of the first message being an integer greater than 1 is used to trigger the second signal.

In one embodiment, the second signal is a physical-layer reference signal.

In one embodiment, when the first signal is received, the first time resource ends.

In one embodiment, when the second signal is received, the first time resource ends.

In one embodiment, the second signal indicates whether there exists the first signal, and the second signal is earlier than the first signal.

In one embodiment, the first signal indicates whether there exists the second signal, and the first signal is earlier than the second signal.

In one embodiment, the first signal and the second signal occupy different resource pools.

In one embodiment, the first signal and the second signal occupy different frequency-domain resources.

In one embodiment, the advantage of the above method is that the first signal and the second signal are transmitted on different resources, which is conducive to improving accuracy of positioning; the difference in resource pools between a first signal and a third signal is also beneficial for improving positioning accuracy.

In one embodiment, the second message is an LPP message.

In one embodiment, a receiver of the second message is an LMF.

In one subembodiment of the above embodiment, the LMF is a functional entity within the core network.

In one embodiment, the second message is forwarded through the second node U02.

In one embodiment, a receiver of the second message is a node other than the second node U02.

In one embodiment, the second message is an internal message of the first node U01.

In one embodiment, the first message indicates a resource pool occupied by the second signal or occupied frequency-domain resources.

In one embodiment, a reception of the first SCI is not used to trigger starting an inactivity timer of sidelink DRX.

In one embodiment, a reception of the first signal is used to trigger stopping an inactivity timer of sidelink DRX.

In one embodiment, the second message comprises a measurement result of a second signal.

In one embodiment, the second message comprises measurement results of the first signal and a second signal.

In one embodiment, the second message comprises that a measurement result is generated by the first signal and the second signal together.

In one embodiment, the second message comprises timestamps respectively for the first signal and the second signal.

### Embodiment 6

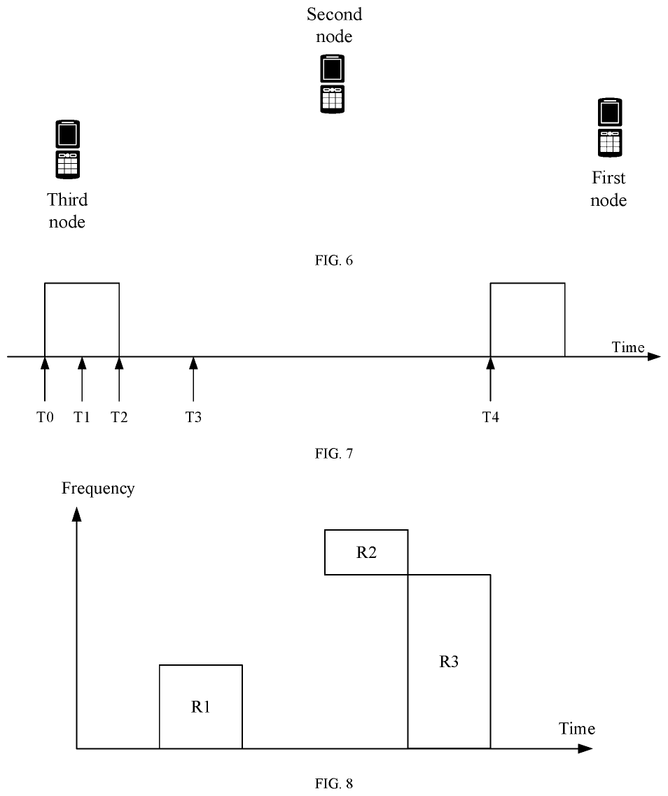

Embodiment 6 illustrates a schematic diagram of three nodes according to one embodiment of the present application, as shown in FIG. 6.

A first node in embodiment 6 corresponds to the first node in the present application, and a second node in embodiment 6 corresponds to the second node in the present application.

In one embodiment, a third node in FIG. 6 is a UE.

In one embodiment, a third node in FIG. 6 is a base station.

In one embodiment, a third node in FIG. 6 is a cluster head.

In one embodiment, a PC5 RRC connection is established between the first node and the third node.

In one embodiment, a PC5 RRC connection is established between the second node and the third node.

In one embodiment, a PC5 RRC connection is not established between the first node and the third node.

In one embodiment, a PC5 RRC connection is not established between the second node and the third node.

In one embodiment, a PC5 RRC connection is established between the first node and the second node.

In one embodiment, a PC5 RRC connection is not established between the first node and the second node.

In one embodiment, the first node, the second node and the third node belong to a same group.

In one embodiment, the first message is transmitted by broadcast or groupcast.

In one embodiment, the first signal is unicast.

In one embodiment, the first signal triggers the third node transmitting a fourth signal, the fourth signal is a physical-layer reference signal, the fourth signal is used for positioning, and the first location information comprised in the second message is based on a measurement performed on the fourth signal.

In one embodiment, the fourth signal is unicast.

In one embodiment, the first message is groupcast, and both the first signal and the fourth signal are unicast.

In one embodiment, the first message is unicast, and the first signal is groupcast.

In one embodiment, the second node reports a measurement result of the fourth signal to the first node.

In one subembodiment of the embodiment, the second node reports a measurement result of the fourth signal to the first node through second location information.

In one embodiment, the second node transmits a third message, and the first node receives the third message.

In one subembodiment of the embodiment, the third node comprises third location information, and a measurement performed on the third location information is based on the third signal.

In one embodiment, a receiver of the second message is the second node, and the second message is used for a positioning of the second node.

In one embodiment, a receiver of the second message is the second node, and the second message is used for a positioning of the second node for the first node.

In one embodiment, the third node transmits a fourth message, and the fourth message triggers the first node transmitting the first message.

In one subembodiment of the above embodiment, the fourth message is an RRC message of a PC5 interface.

In one subembodiment of the above embodiment, the fourth message is a PC5-S message.

In one embodiment, the first signal is used by the third node for positioning the second node.

In one embodiment, the third node is a receiver of the second message.

In one subembodiment of the embodiment, the third node is a UE.

In one subembodiment of the embodiment, the third node comprises an LMF.

### Embodiment 7

Embodiment 7 illustrates a schematic diagram of a reception and transmission time according to one embodiment of the present application, as shown in FIG. 7.

In one embodiment, the box in FIG. 7 represents an active time of sidelink DRX of the second node, and a duration of the active time of sidelink DRX of the second node starts from time T0 and ends at time T2.

In one embodiment, an active time of sidelink DRX of the second node is discontinuous.

In one embodiment, a transmission time of the first message is T1 time, and the T1 time is any time between T0 and T2.

In one embodiment, a reception time of the first signal is T3 time, and the T3 time is a time later than T1.

In one embodiment, the T3 time is later than time T2.

In one embodiment, the T3 time is earlier than time T2.

In one embodiment, the T3 time is unrelated to time T2.

In one embodiment, the first time resource starts from T1 time and ends at time T3.

In one embodiment, whether the first SCI indicates the first signal is used to determine whether the first SCI triggers starting or re-starting an inactivity timer of sidelink DRX.

In one embodiment, an active time of a sidelink DRX comprises a running time of an onduration timer of sidelink DRX.

In one embodiment, an active time of a sidelink DRX comprises a running time of an inactivity timer of sidelink DRX.

In one embodiment, an active time of a sidelink DRX comprises a running time of a retransmission timer of sidelink DRX.

In one embodiment, an onduration timer for a sidelink DRX of the second node starts at T0 time.

In one embodiment, an onduration timer for a sidelink DRX of the second node starts at T4 time.

In one embodiment, the second node comprises a second time resource for an active time of a sidelink DRX of the first node, and the second time resource depends on receiving the first message.

In one embodiment, the second node comprises a second time resource for an active time of a sidelink DRX of the first node, and the second time resource depends on transmitting the first signal.

In one embodiment, the second node comprises a second time resource for an active time of a sidelink DRX of the first node, and the second time resource depends on transmitting the first SCI.

### Embodiment 8

Embodiment 8 illustrates a schematic diagram of a resource pool according to one embodiment of the present application, as shown in FIG. 8.

FIG. 8 illustrates the situation where the first node and the second node use multiple resource pools, and FIG. 8 illustrates three resource pools, namely R1, R2, and R3. However, the method proposed in the present application is not limited to a number of resource pool(s).

In one embodiment, the method proposed in the present application is applicable to sidelink communications of unlicensed spectrum.

In one embodiment, the first message is transmitted in resource pool R1, and the first signal is received in R2.

In one embodiment, the first message is transmitted in resource pool R1, and the first signal is received in R3.

In one embodiment, the first message is transmitted in resource pool R2, and the first signal is received in R3.

In one embodiment, the first SCI and the first signal use a same resource pool.

In one embodiment, the first time resource is related to whether the first message is the same as a resource pool used by the first signal.

In one subembodiment of the embodiment, when the first message and the first signal use different resource pools, such as R1 and R2, the used different resource pools are spaced by T time units in time domain, where T is greater than 0, and a maximum allowable length of the first time resource is T+X slots; when the first message and the first signal use different resource pools, the used different resource pools are adjacent in time domain, and a maximum allowable length of the first time resource is X slot(s); when the first message and the first signal use a same resource pool and a maximum allowable length of the first time resource is X slot(s), X being a positive integer.

In one embodiment, whether a resource pool occupied by the first signal is positioning dedicated is used to determine whether a reception of the first SCI triggers starting an inactivity timer of sidelink DRX.

In one subembodiment of the embodiment, when a resource pool occupied by the first signal is a positioning-dedicated resource pool, the first SCI does not trigger starting an inactivity timer of a sidelink DRX; when a resource pool occupied by the first signal is not a positioning-dedicated resource pool, the first SCI triggers starting an inactivity timer of a sidelink DRX.

In one embodiment, the meaning of the phrase that the first SCI is used to determine time-domain resources occupied by the first signal comprises: the first SCI indicates time-frequency resources occupied by a first MAC PDU, and the first MAC PDU comprises time-frequency resources occupied by the first signal.

In one subembodiment of the embodiment, a MAC sub-header comprised in the first MAC PDU indicates resources occupied by the first signal.

In one subembodiment of the embodiment, a MAC CE comprised in the first MAC PDU indicates resources occupied by the first signal.

In one subembodiment of the embodiment, an LCID comprised in the first MAC PDU indicates resources occupied by the first signal.

In one embodiment, the meaning of the phrase that the first SCI is used to determine time-domain resources occupied by the first signal comprises: the first SCI indicates resources occupied by an SL-SCH channel, the SL-SCH channel is used for bearing a first MAC PDU, and the first MAC PDU comprises time-frequency resources occupied by the first signal.

In one subembodiment of the embodiment, a MAC sub-header comprised in the first MAC PDU indicates resources occupied by the first signal.

In one subembodiment of the embodiment, a MAC CE comprised in the first MAC PDU indicates resources occupied by the first signal.

In one subembodiment of the embodiment, an LCID comprised in the first MAC PDU indicates resources occupied by the first signal.

In one embodiment, a format of the first SCI is SCI format-D.

In one embodiment, a rd stage format of the first SCI is SCI format-D.

In one embodiment, an SCI format used to indicate a MAC PDU carrying an SDU above the MAC layer is format A or format B.

In one embodiment, the first SCI comprises 3rd-stage SCI, and the 3rd-stage SCI comprised in the first SCI is used to indicate time-frequency resources occupied by the first signal.

In one embodiment, frequency-domain resources occupied by the first signal are pre-configured through an RRC message of a PC5 interface.

In one subembodiment of the above embodiment, an RRC message of the PC5 interface is transmitted and received before the first message.

### Embodiment 9

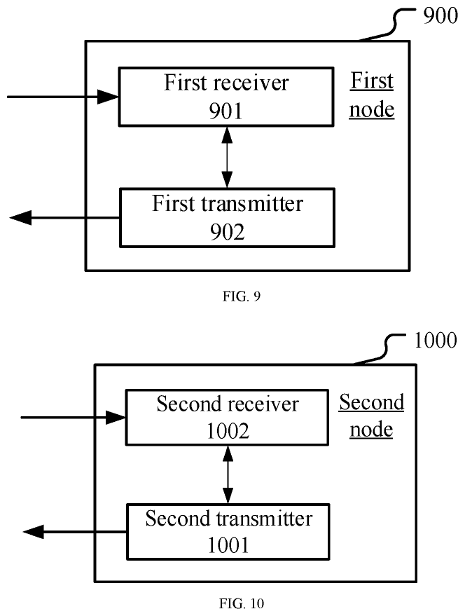

Embodiment 9 illustrates a structure block diagram of a processor in a first node according to one embodiment of the present application, as shown in FIG. 9. In FIG. 9, a processor 900 of a first node comprises a first receiver 901 and a first transmitter 902. In Embodiment 9,
the first transmitter 902, transmits a first message on sidelink, the first message is used to trigger a first signal; transmits a second message, the second message comprises first location information, the first location information is based on a measurement performed on the first signal;
the first receiver 901 monitors an SCI during an active time of a sidelink DRX; and receives the first signal through sidelink;
herein, the active time of the sidelink DRX comprises a first time resource, and the first time resource depends on a transmission time of the first message.

In one embodiment, the behavior of monitoring an SCI during an active time of a sidelink DRX comprises detecting a first SCI; herein, the first SCI is used to determine time-domain resources occupied by the first signal.

In one embodiment, the first message is MAC-layer control information; a first MAC PDU comprises the first message; the first MAC PDU comprises a first MAC sub-header, a first field of the first MAC sub-header comprises N1 bit(s) of a first identity of the first node, and a second field of the first MAC sub-header comprises N2 bit(s) of a second identity; the first identity of the first node and the second identity are respectively link-layer identities, and the first identity of the first node and the second identity respectively comprise N bits, N being greater than N1, N being greater than N2; the second identity is related to a transmitter of the first signal.

In one embodiment, the first message is an SCI; the first message comprises N2 bit(s) of a first identity of the first node, and the first message comprises N1 bit(s) of a second identity; the first identity of the first node and the second identity are respectively link-layer identities, and the first identity of the first node and the second identity respectively comprise N bits, N being greater than N1, N being greater than N2; the second identity is related to a transmitter of the first signal.

In one embodiment, the first receiver 901 receives a second signal on sidelink.
the first message is used to trigger the second signal; a reception of the second signal is later than a reception of the first signal; the first location information is based on a measurement performed on the second signal; the first time resource depends on one of a transmission time or a reception time of the second signal.

In one embodiment, the first transmitter 902, accompanying the first message, transmits a third signal on sidelink, and the third signal is used to determine a location of the first node; both the third signal and the first signal are physical-layer reference signals.

In one embodiment, the first node is a UE.

In one embodiment, the first node is a terminal that supports large delay differences.

In one embodiment, the first node is a terminal that supports NTN.

In one embodiment, the first node is an aircraft or vessel.

In one embodiment, the first node is a mobile phone or vehicle terminal.

In one embodiment, the first node is a relay UE and/or U2N remote UE.

In one embodiment, the first node is an Internet of Things (IoT) terminal or an Industrial Internet of Things (IIoT) terminal.

In one embodiment, the first node is a device that supports transmission with low-latency and high-reliability.

In one embodiment, the first node is a sidelink communication node.

In one embodiment, the first node is an access network.

In one embodiment, the first receiver 901 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 902 comprises at least one of the antenna 452, the transmitter 454, the transmitting processor 468, the multi-antenna transmitting processor 457, the controller/processor 459, the memory 460 or the data source 467 in Embodiment 4.

### Embodiment 10

Embodiment 10 illustrates a structure block diagram of a processor in a second node according to one embodiment of the present application, as shown in FIG. 10. In FIG. 10, a processor 1000 in a second node comprises a second receiver 1002 and a second transmitter 1001. In Embodiment 10,
the second receiver 1002 receives a first message on sidelink;
the second transmitter 1001 transmits a first signal on sidelink;
herein, a transmitter of the first message transmits a second message, the second message comprises first location information, and the first location information is based on a measurement performed on the first signal; the first message is used to trigger the first signal; the active time of the sidelink DRX comprises a first time resource, and the first time resource depends on a transmission time of the first message.

In one embodiment, the second transmitter 1001 transmits a first SCI; the first SCI is used to determine time-domain resources occupied by the first signal.

In one embodiment, the first message is MAC-layer control information; a first MAC PDU comprises the first message; the first MAC PDU comprises a first MAC sub-header, a first field of the first MAC sub-header comprises N1 bit(s) of a first identity of the first node, and a second field of the first MAC sub-header comprises N2 bit(s) of a second identity; the first identity of the first node and the second identity are respectively link-layer identities, and the first identity of the first node and the second identity respectively comprise N bits, N being greater than N1, N being greater than N2; the second identity is related to a transmitter of the first signal.

In one embodiment, the first message is an SCI; the first message comprises N2 bit(s) of a first identity of the first node, and the first message comprises N1 bit(s) of a second identity; the first identity of the first node and the second identity are respectively link-layer identities, and the first identity of the first node and the second identity respectively comprise N bits, N being greater than N1, N being greater than N2; the second identity is related to a transmitter of the first signal.

In one embodiment, the second transmitter 1001, as a response to receiving the first message, transmits a second signal on sidelink;
a transmission of the second signal is later than a transmission of the first signal; the first location information is based on a measurement performed on the second signal; the first time resource depends on one of a transmission time or a reception time of the second signal.

In one embodiment, the second receiver 1002, receives a third signal on sidelink, and the third signal is used to determine a location of a transmitter of the first message; both the third signal and the first signal are physical-layer reference signals.

In one embodiment, the first time resource starts after a determined time offset after the first message is transmitted.

In one embodiment, the second node is a satellite.

In one embodiment, the second node is a U2N Relay UE.

In one embodiment, the second node is an IoT node.

In one embodiment, the second node is a wearable node.

In one embodiment, the second node is a relay.

In one embodiment, the second node is an access point.

In one embodiment, the second node is a node supporting multicast.

In one embodiment, the second node is a UE.

In one embodiment, the second node is a terminal.

In one embodiment, the second node is a mobile phone.

In one embodiment, the second transmitter 1001 comprises at least one of the antenna 420, the transmitter 418, the transmitting processor 416, the multi-antenna transmitting processor 471, the controller/processor 475 or the memory 476 in Embodiment 4.

In one embodiment, the second receiver 1002 comprises at least one of the antenna 420, the receiver 418, the receiving processor 470, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but not limited to unmanned aerial vehicles, communication modules on unmanned aerial vehicles, tele-controlled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, satellite communication equipment, vessel communication equipment, NTN UEs, etc. The base station or system device in the present application includes but is not limited to macro-cellular base stations, micro-cellular base stations, home base stations, relay base station, gNB (NR node B), Transmitter Receiver Point (TRP), NTN base stations, satellite equipment, flight platform equipment and other radio communication equipment.

This application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first transmitter, transmitting a first message on sidelink, the first message being used to trigger a first signal; transmitting a second message, the second message comprising first location information, the first location information being based on a measurement performed on the first signal;
a first receiver, monitoring Sidelink Control Information (SCI) during an active time of a sidelink Discontinuous Reception (DRX); and receiving the first signal through sidelink;
wherein the active time of the sidelink DRX comprises a first time resource, and the first time resource depends on a transmission time of the first message.

2. The first node according to claim 1, wherein the behavior of monitoring an SCI during an active time of a sidelink DRX comprises detecting a first SCI; wherein the first SCI is used to determine time-domain resources occupied by the first signal.

3. The first node according to claim 1, wherein the first message is Media Access Control (MAC) layer control information; a first MAC Protocol Data Unit (PDU) comprises the first message; the first MAC PDU comprises a first MAC sub-header, a first field of the first MAC sub-header comprises N1 bit(s) of a first identity of the first node, and a second field of the first MAC sub-header comprises N2 bit(s) of a second identity; the first identity of the first node and the second identity are respectively link-layer identities, and the first identity of the first node and the second identity respectively comprise N bits, N being greater than N1, N being greater than N2; the second identity is related to a transmitter of the first signal.

4. The first node according to claim 2, wherein the first message is MAC-layer control information; a first MAC PDU comprises the first message; the first MAC PDU comprises a first MAC sub-header, a first field of the first MAC sub-header comprises N1 bit(s) of a first identity of the first node, and a second field of the first MAC sub -header comprises N2 bit(s) of a second identity; the first identity of the first node and the second identity are respectively link-layer identities, and the first identity of the first node and the second identity respectively comprise N bits, N being greater than N1, N being greater than N2; the second identity is related to a transmitter of the first signal.

5. The first node according to claim 1, wherein the first message is an SCI; the first message comprises N2 bit(s) of a first identity of the first node, and the first message comprises N1 bit(s) of a second identity; the first identity of the first node and the second identity are respectively link-layer identities, and the first identity of the first node and the second identity respectively comprise N bits, N being greater than N1, N being greater than N2; the second identity is related to a transmitter of the first signal.

6. The first node according to claim 2, wherein the first message is an SCI; the first message comprises N2 bit(s) of a first identity of the first node, and the first message comprises N1 bit(s) of a second identity; the first identity of the first node and the second identity are respectively link-layer identities, and the first identity of the first node and the second identity respectively comprise N bits, N being greater than N1, N being greater than N2; the second identity is related to a transmitter of the first signal.

7. The first node according to claim 1, comprising:
a first receiver, receiving a second signal on sidelink;
the first message is used to trigger the second signal; a reception of the second signal is later than a reception of the first signal; the first location information is based on a measurement performed on the second signal; the first time resource depends on one of a transmission time or a reception time of the second signal.

8. The first node according to claim 2, comprising:
a first receiver, receiving a second signal on sidelink;
the first message is used to trigger the second signal; a reception of the second signal is later than a reception of the first signal; the first location information is based on a measurement performed on the second signal; the first time resource depends on one of a transmission time or a reception time of the second signal.

9. The first node according to claim 3, comprising:
a first receiver, receiving a second signal on sidelink;
the first message is used to trigger the second signal; a reception of the second signal is later than a reception of the first signal; the first location information is based on a measurement performed on the second signal; the first time resource depends on one of a transmission time or a reception time of the second signal.

10. The first node according to claim 5, comprising:
a first receiver, receiving a second signal on sidelink;
the first message is used to trigger the second signal; a reception of the second signal is later than a reception of the first signal; the first location information is based on a measurement performed on the second signal; the first time resource depends on one of a transmission time or a reception time of the second signal.

11. The first node according to claim 1, comprising:
the first transmitter, accompanying the first message, transmitting a third signal on sidelink, and the third signal being used to determine a location of the first node; both the third signal and the first signal being physical-layer reference signals.

12. The first node according to claim 2, comprising:
the first transmitter, accompanying the first message, transmitting a third signal on sidelink, and the third signal being used to determine a location of the first node; both the third signal and the first signal being physical-layer reference signals.

13. The first node according to claim 6, comprising:
the first transmitter, accompanying the first message, transmitting a third signal on sidelink, and the third signal being used to determine a location of the first node; both the third signal and the first signal being physical-layer reference signals.

14. The first node according to claim 7, comprising:
the first transmitter, accompanying the first message, transmitting a third signal on sidelink, and the third signal being used to determine a location of the first node; both the third signal and the first signal being physical-layer reference signals.

15. The first node according to claim 1, wherein the second message comprises a first timestamp, the first timestamp is referenced to a timing of a third node, i.e., a node other than the first node and a transmitter of the first signal.

16. The first node according to claim 1, wherein the first time-frequency resource is unrelated to whether an onduration timer, an inactivity timer and a retransmission timer for the sidelink DRX is running.

17. The first node according to claim 1, wherein the first signal is a reference signal dedicated for positioning.

18. The first node according to claim 2, wherein the first signal is a reference signal dedicated for positioning.

19. The first node according to claim 3, wherein the first signal is a reference signal dedicated for positioning.

20. A method in a first node for wireless communications, comprising:
transmitting a first message on sidelink, the first message being used to trigger a first signal; transmitting a second message, the second message comprising first location information, the first location information being based on a measurement performed on the first signal; and
monitoring an SCI during an active time of a sidelink DRX; and receiving the first signal through sidelink;
wherein the active time of the sidelink DRX comprises a first time resource, and the first time resource depends on a transmission time of the first message.
